(19) United States
(12) Patent Application Publication
(10) Pub. No.: US 2020/0198168 A1
(43) Pub. Date: Jun. 25, 2020

(54) CUTTING MACHINE FOR STRAND-LIKE MATERIAL TO BE CUT

(71) Applicant: TVI Entwicklung & Produktion GmbH, Irschenberg (DE)

(72) Inventor: Thomas Völkl, Bruckmühl (DE)

(21) Appl. No.: 16/717,126

(22) Filed: Dec. 17, 2019

(30) Foreign Application Priority Data
Dec. 18, 2018 (DE) 102018132654.8

(51) Int. Cl. B26D 7/26; B26D 1/00; B26D 7/01

(52) U.S. Cl. CPC B26D 7/2628; B26D 1/0006; B26D 1/147; B26D 2001/002; B26D 2210/02; B26D 7/01

(57) ABSTRACT

The invention concerns a device and a method for guiding the blade (3) at the cutting end face (1a) of the guide tube (1) by means of magnetic force in order to bring the cutting spacing as close as possible, if possible to zero. According to the invention, the magnetic force is applied to the blade only towards the end of the cutting process of the slice (101), i.e. near the outlet side (2a) of the cutting edge (3a) from the guide tube cross-section (1.1′, 1.2′).

### I. FIELD OF APPLICATION

The invention concerns cutting machines in which slices are to be cut from a strand-shaped or loaf-shaped material.

### II. TECHNICAL BACKGROUND

The material to be cut is often guided in a guide tube, whereby the portion of the material to be cut protruding from the guide tube on the front side of the cutting side is cut off as a slice by a rotating blade, for example, directly on the front surface of the guide tube on the cutting side.

At this point, it should be made clear that this guide tube can also consist only of an axially very short so-called cutting screen, which partially or completely surrounds the end of the material to be cut from which the slices are to be cut, and at the end face of which the blade moves along. In the following, however, only one guide tube is spoken of.

It should also be clarified that the present notification also covers solutions where a single blade cuts a slice simultaneously from two or more loaves guided in adjacent guide tubes and/or solutions where the guide tube is part of a guide tube revolver rotating about its central axis and around which several guide tubes are arranged.

The blade should always cut through the material to be cut at the same, exactly defined axial distance, in particular the distance zero, to the end face of the guide tube, because only in this way slices with a defined thickness and thus also with a defined weight can be produced.

The e.g. rotating blade is supported on the side of the guide tube by the guide tube itself, on the opposite side a support is necessary, which requires axial space—by the correspondingly large thickness of the blade itself or an additional support device there—but disadvantageous, because the penetration of the blade into the material to be cut is made more difficult.

Theoretically, an optimally thin blade would be the best solution, as it penetrates the material to be cut most easily, but such a blade often does not have sufficient dimensional stability and, above all, sufficient positional stability for lying close to the end face of the guide tube.

In the case of a product with a uniform consistency and low cutting resistance, such as sausage or cheese—which generally also has a uniform cross-section over the axial direction and is thus strand-like—this problem is not as acute as with an irregularly structured and loaf shaped product to be sliced, such as a piece of fresh meat, which can then additionally be prepressed in the guide tube as a shaping tube in the longitudinal direction and/or transverse direction before cutting.

The non-uniform cross-section of the meat loaf is extended to the uniform cross-section of the guide tube, so that the material to be cut has a uniform cross-section in the form of a strand or caliber, which also causes the material to be cut to be under increased pressure and which should be provided outside the guide tube with a longitudinal stop for the end of the material to be cut pushed out of the guide tube.

Since the blade is not guided on both sides in a cutting slit, but only slides along the end face of the guide tube on one side, there is a high risk, without additional measures, that the blade will not slide closely along the end face of the guide tube due to deformation, the irregular resistance of the material to be cut or other effects, in particular not contacting, but at a small distance from the end face, which undesirably changes the thickness and thus the weight of the slice produced.

Above all, however, this does not result in a good cutting result of the slice, which is only achieved if the cutting edge of the blade slides along the outlet side of the guide tube without distance and against a counter cutting edge, in this case in the form of the inner circumference of the guide tube opening of the guide tube.

If this is not the case, the edge of the slice is usually frayed, which is undesirable for optical reasons.

A grown piece of meat is surrounded by a so-called silver skin, a tendon-like material that is difficult to cut. True cutting instead of tearing through this silver skin is only possible if the cutting edge of the blade is in contact with the face of the guide tube or form revolver, especially when the blade exits the material to be cut, i.e. the cross-section of the guide tube.

It is already known from DE 10 2010 035 656 A1 that holding magnets or vacuum air nozzles are arranged in the front face of the guide tube close to the circumference of the guide tube opening in order to pull the blade towards the front face of the guide tube during the entire cutting process, preferably until it makes contact.

It has been shown, however, that this leads to increased friction between the blade and the guide tube, and thus on the one hand to a heating of these components and also of the material to be cut which is absorbed in it, and on the other hand to increased force required to move the blade.

### III. DESCRIPTION OF THE INVENTION

### a) Technical Object

It is therefore the objective, according to the invention, to provide a device and a method for pulling the blade towards the cutting end face of the guide tube of a cutting machine and still avoid the described disadvantages.

### b) Achievement of the Objective

This objective is solved by the characteristics of claims 1 and 15. Advantageous embodiments result from the subclaims.

In the case of a generic cutting machine in which the blade is held to the end face of the guide tube by means of holding magnets, it is irrelevant whether the blade is a beam-shaped blade, a rotating circular disc-shaped blade, a rotating sickle-shaped blade or the blade of a band saw.

In a cutting machine according to the invention, the holding magnet or magnets are arranged in the direction of penetration of the blade only near the outlet side of the guide tube cross-section and outside the guide tube cross-section, and not near the inlet side.

The direction of penetration is the perpendicular to the blade edge, which is located in the blade plane defined by the blade edge and/or the main plane of the blade. If the edge of the blade is curved, the vertical one starts at the middle of the length of the edge of the blade.

As a result, the blade is only subjected to magnetic force in the direction to the end face of the guide tube in the last part of the passing distance of its blade edge through the material to be cut, i.e. through the guide tube cross-section and is thus usually brought into contact with the end face.

On the one hand, this causes the cutting edge of the blade to shear off from the front edge of the inner circumference of the guide tube cross-section as a counter-blade, which results in an exact cut, so that the silver skin is also cut correct without any problems.

In addition, this offers the advantage that before the magnetic force acts on the blade, i.e. in the first part of the cutting edge passage along the penetration distance, the blade is not yet subjected to magnetic force in the direction of the end face of the guide tube and the blade does not contact the end face or only contacts it with a very low contact force, so that there is hardly any heating of the blade and guide tube and hardly any increase in the cutting force to be applied.

In particular, the holding magnet or magnets are only arranged in the last third of the penetration distance of the blade edge in the direction of penetration.

The at least one holding magnet is arranged as close as possible to the outer circumference of the guide tube cross-section in order to apply magnetic force to the blade in the direction of the end face, especially in the area of the guide tube cross-section.

Preferably, the holding magnet is arranged transverse to the direction of penetration, i.e. in the radial direction of the guide tube cross-section, closer than 30 mm, better closer than 20 mm, better closer than 10 mm to the circumference of the guide tube cross-section.

In the axial direction, the one or more holding magnets are arranged so close to the longitudinal position of the front, cutting end face of the guide tube, that the tensile force of the holding magnet on the blade at the longitudinal position of the front, cutting end face still reaches or exceeds a predetermined minimum tensile force.

The longitudinal position of the holding magnet is preferably adjustable for this purpose.

The minimum tensile force of the individual magnet mounted in the machine at the longitudinal position of the cutting end face should be at least between 100 N and 10 N, better between 70 N and 20 N, better between 50 N and 30 N, especially against the blade material used.

The sum of the minimum tensile forces of all holding magnets present on a guide tube should be between 400 N and 40 N, better between 280 N and 160 N, better between 200 N and 120 N, especially against to the blade material used. All holding magnets present on a guide tube should in particular be those holding magnets which, when a slice protruding from this guide tube is cut off, act jointly on the cutting blade at most.

Only then is a secure contacting of the blade edge against the front face ensured from the moment the blade is subjected to magnetic force.

The preferred material used for the blade is so-called blade steel, which is usually defined in such a way that its variety number begins with 1.40-1.46, preferably with 1.40.

In particular, the nickel content should not exceed 2.5% by weight and the carbon content should not exceed 1.2% by weight, while the chromium content should be at least 10.5% by weight, preferably 13-15% by weight. If molybdenum is present, its content should not exceed 1.0% by weight.

As a result, such blade steels are stainless and still hardenable, with hardness levels of 50-60 HRC usually being aimed for.

The counter number following in the variety number is preferably between 16 and 34 and preferably 21.

The following last two numerals of the variety number for the steelmaking process and the treatment state are preferably 3 for the steelmaking process and/or 4 for the treatment state.

Preferably a steel of the variety number 1.4021.34 is used as blade steel.

The steel used for the blade must of course be capable of being subjected to magnetic force, i.e. it must be a soft magnetic material.

Preferably the blade is positioned opposite the end face of the guide tube in the axial direction in such a way that the side of the blade facing the guide tube takes up a narrow cutting spacing of not more than 0.5 mm, better not more than 0.3 mm, better not more than 0.2 mm to the guide tube without being subjected to magnetic force.

In order to draw the blade towards the end face by means of the magnetic force of at least one holding magnet until contact is made—if the blade does not contact the end face without being subjected to magnetic force—the blade should have a thickness of not more than 10 mm, in particular not more than 8 mm, in particular not more than 6 mm, in particular not more than 4 mm, in particular not more than 3 mm.

For the same reason, the blade should have an extension of at least 10 mm in the direction of penetration, in particular at least 30 mm, in particular at least 50 mm. In the case of a disc-shaped rotating blade, the extension from the cutting edge to the bearing block in which the blade is mounted shall be measured.

The blade is usually made of a soft magnetic material anyway, i.e. a material on which a force can be exerted by means of a magnet. For hygienic reasons, the blade is preferably made of stainless steel, i.e. a high-alloy steel that does not rust under the operating conditions of such a cutting machine, but at the same time has soft magnetic properties.

Preferably, the blade is only a one-sided ground blade, whereby the ground side is preferably on the side of the blade remote from the guide tube. Therefore, regardless of the exact dimensions of the blade, i.e. its regrinding condition, no changes need to be made to the positioning of the magnets, especially in the axial direction.

### c) EXEMPLARY EMBODIMENTS

The following are examples of the embodiments according to the invention:

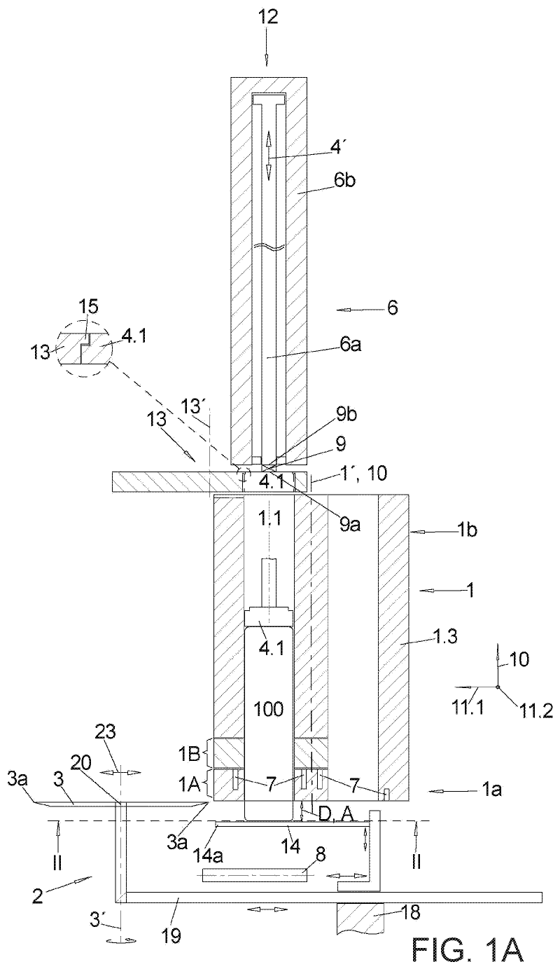

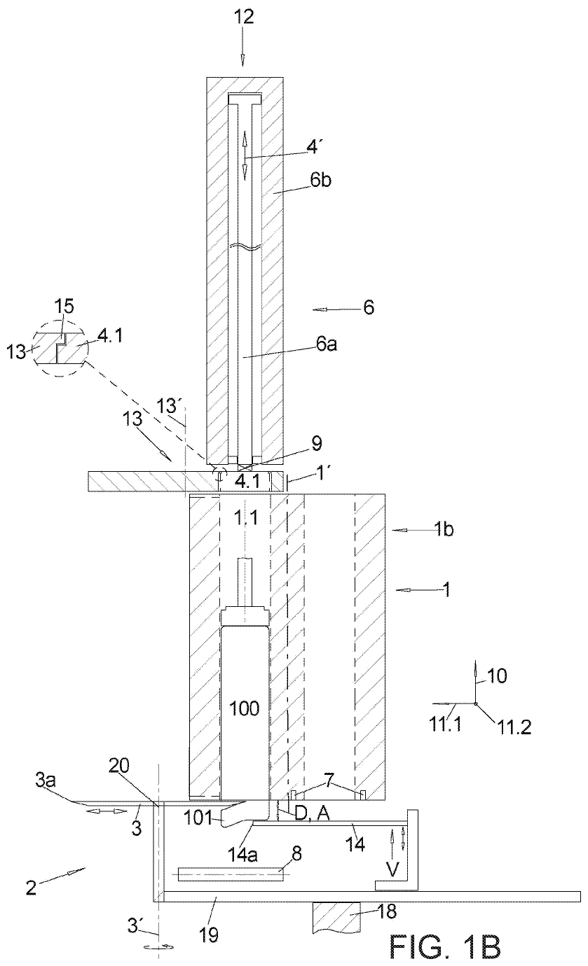

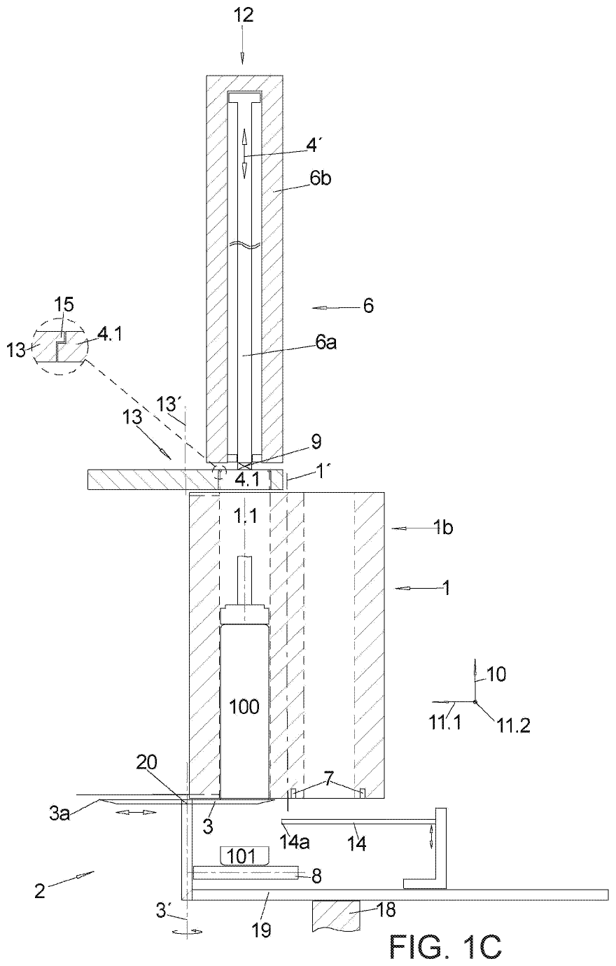

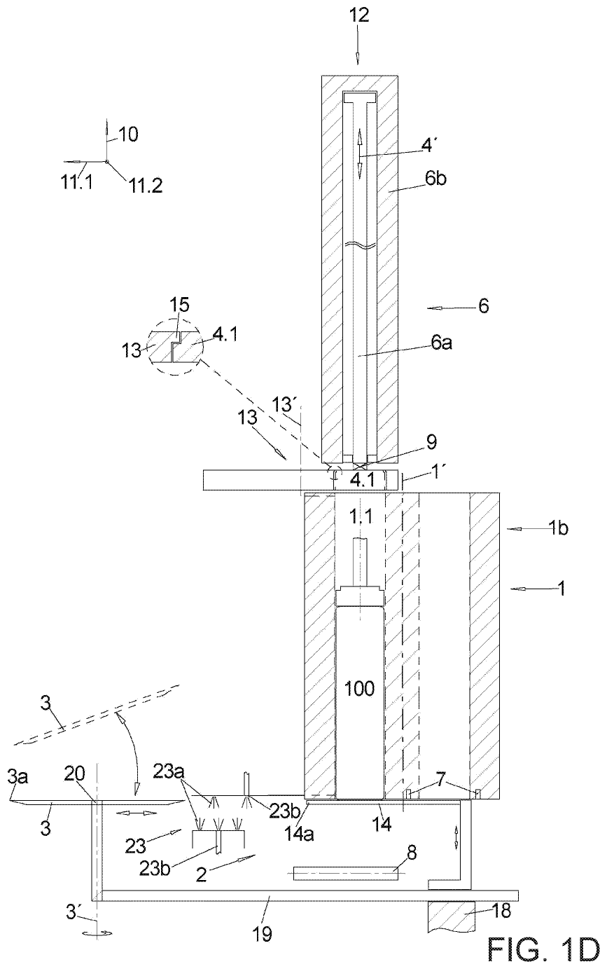

FIGS. 1a-d: a cutting machine in a longitudinal cross-section in different working positions,

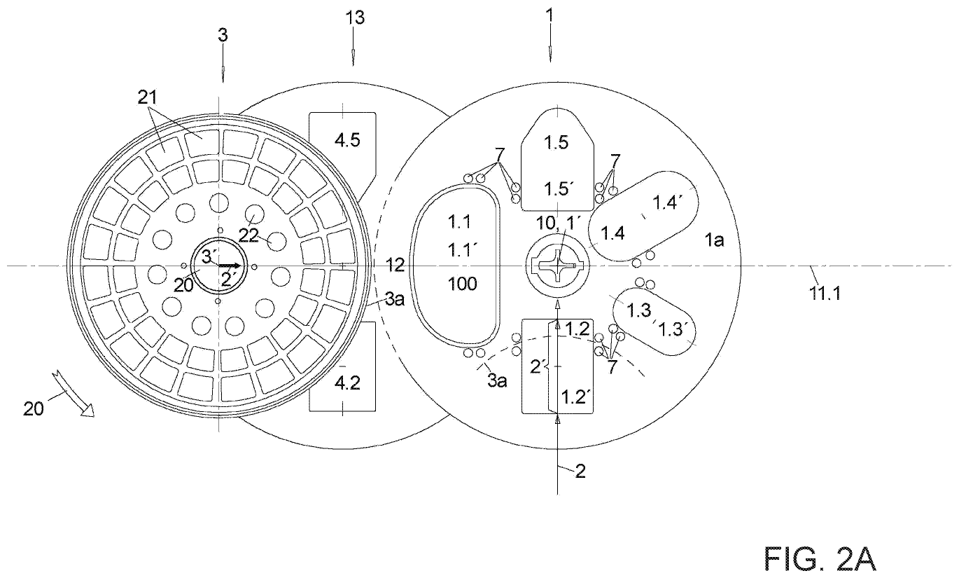

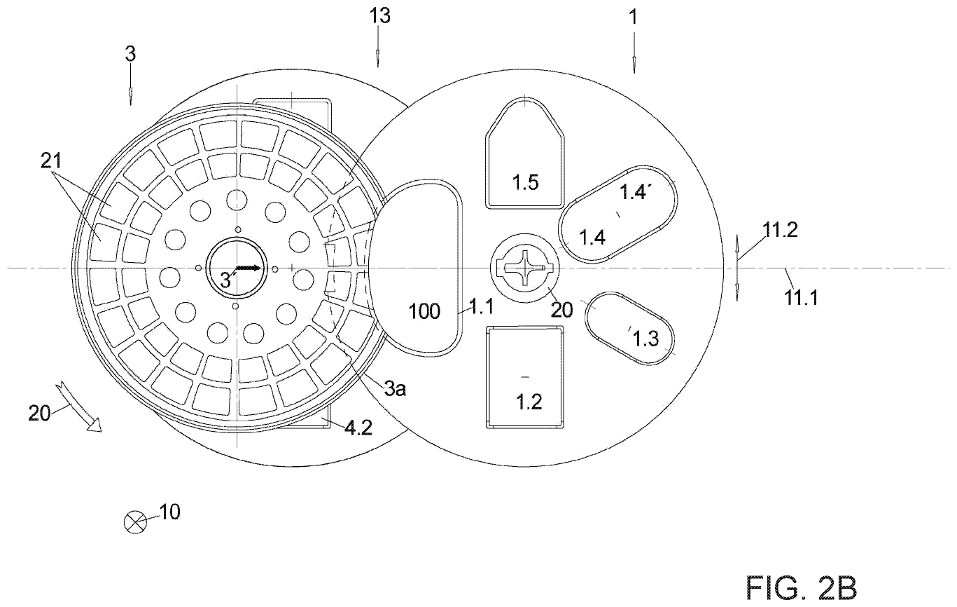

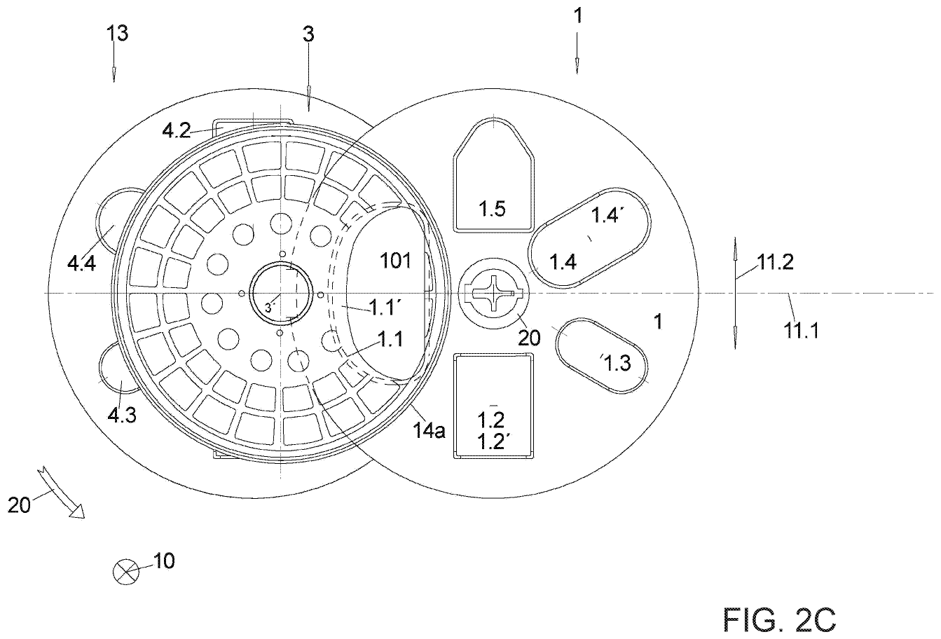

FIGS. 2a-c: a cross-section of the cutting machine along line II-II in different working positions,

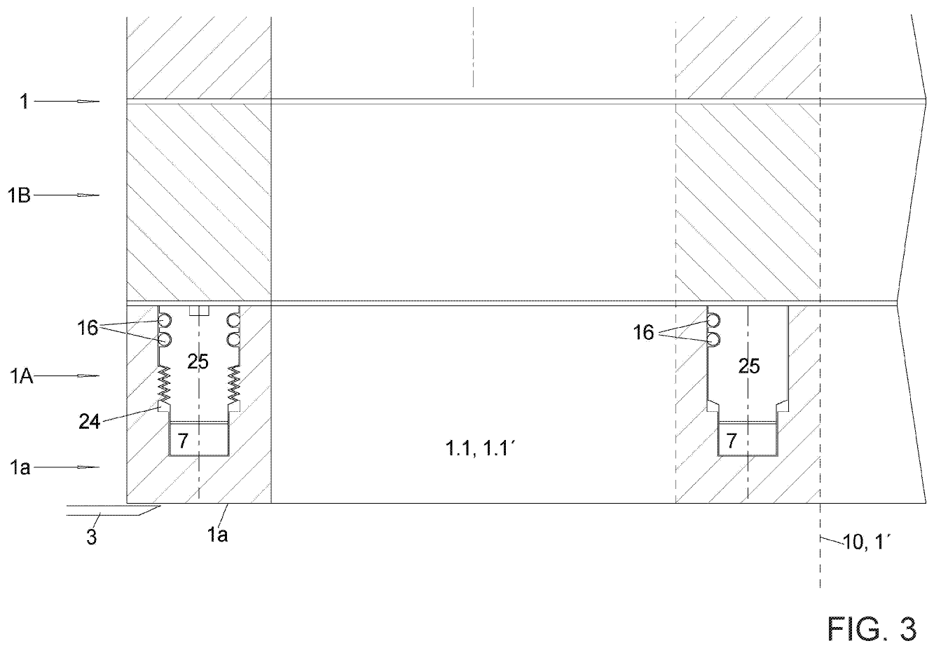

FIG. 3: an enlargement from FIG. 1a,

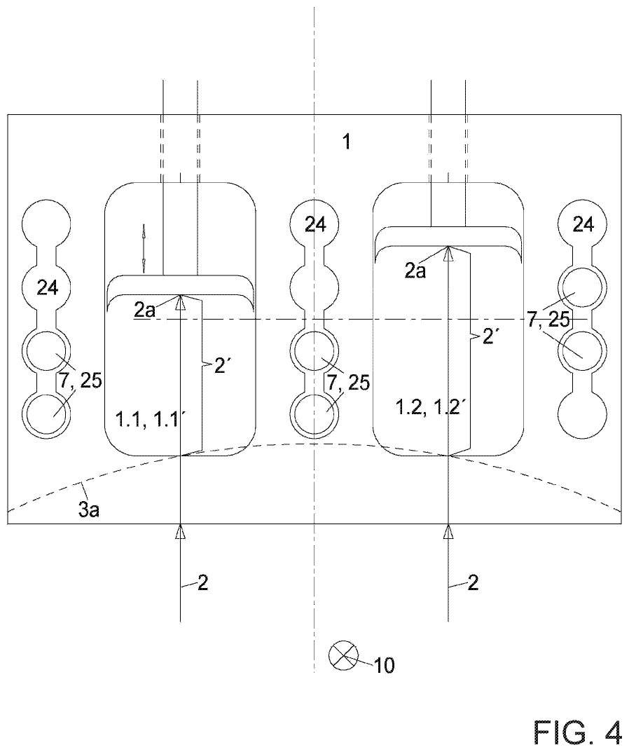

FIG. 4: a view of a double guide tube.

The basic, generic construction of the cutting machine can best be explained by looking at the FIGS. 1a and 2a together:

A guide tube revolver 1, which in this case is upright and round in cross-section, is mounted rotatably around a rotation axis 1′, which in this case is also upright and represents the axis of symmetry of the cylindrical guide tube revolver 1, in the—not shown—base frame of the cutting machine.

Along the circumference, there are several axially running guide tube openings 1.1-1.5 with different free inner cross-sections 1.1′-1.5′ in the guide tube revolver 1, which are open both at the front, lower cutting end 1a and at the upper, rear loading end 1b, i.e. are each open at the end faces.

The guide tube openings 1.1-1.5 serve to receive a loaf 100 to be cut into slices, which in its initial state has an elongate but irregular shape, so that in accordance with the cross-section of the loaf 100 in its initial state it can optionally be inserted from above, from the loading end 1b, into a guide tube opening 1.1-1.5 with the best fitting cross-section, which must of course not be in the cutting position 12 for this purpose, since there the longitudinal press drive 6 prevents the insertion from above.

Cutting position 12 is the angular position or angular segment with respect to the axis of rotation 1′ of the guide tube revolver 1 which is swept by the blade in use. In the case of a blade moved radially with respect to the guide tube revolver 1, the cutting position 12 is the angular position at which the penetration direction 2 is located.

Directly in front of, i.e. below, the lower end face 1a, the cutting end 1a of the guide tube 1, there is arranged a rotating, circular disc-shaped blade 3, which is rotationally driven about a blade axis 3′, which preferably lies parallel to the switching axis 1′, the axis of rotation of the guide tube revolver 1.

The rotating blade 3 can be moved back and forth in a 1st transverse direction 11.1 to the longitudinal direction 10, which corresponds to the direction of the switching axis 1′ of the guide tube revolver 1, radially to the guide tube opening located in the cutting position 12, e.g. 1.1, to separate slices 101 from the material to be cut 100.

The separated slice 101 falls onto the discharge conveyor 8 arranged underneath and is transported away by it, e.g. in the direction of view of FIG. 1c.

FIGS. 2a to c show the cutting process of a slice 101 in a view according to FIG. 1a from below at position II-II:

In FIG. 2a and FIG. 1a the blade 3 is still completely outside the circumference of the guide tube revolver 1.

In FIG. 2b, blade 3 and the stop plate 14—which is not visible here—have already moved together so far to the right in the 1st transverse direction 11.1 that blade 3 has already penetrated into loaf 100 and the already cut off part of slice 101 projects beyond the functional edge 14a of stop plate 14 between blade 3 and stop plate 14.

In FIG. 2c and FIG. 1c the slice 101 is completely cut off, the blade 3 completely covers the cross-section of the guide tube opening at the cutting position and the stop plate 14 is completely outside the cross-section 1.1′ of this guide tube opening 1.1 in this viewing direction.

FIG. 2c thus shows the condition immediately before the cut-off slice 101 falls onto the discharge conveyor 8, while in FIG. 1c the slice 101 already lies on the discharge conveyor 8.

Instead of a linear, oscillating movement in the transverse direction 11.1, the blade axis 3′ may also perform an arcuate, oscillating or circular movement to cut-off one slice 101 each.

To produce a uniform cross-section of the loaf 100 before cutting, it is pressed in longitudinal direction 10 in the guide tube opening 1.1 in which it is located.

For longitudinal pressing, a longitudinal press drive 6, viewed in the direction of the switching axis 1′ within the circumference of the guide tube revolver 1, is arranged on the base frame of the machine above the guide tube revolver 1 at the so-called cutting position 12.

The longitudinal press drive 6 consists of a working cylinder, preferably a hydraulic cylinder, whose piston rod 6a, which is displaceable in the longitudinal direction 10, progressively extends from the lower, open end of the cylinder 6b when the working medium is applied and, with its front end, pushes a longitudinal press piston 4.1, which fits into the cross-section 1.1′ of the guide tube opening 1.1 located below, into the latter until it bears against the loaf 100 and presses the latter downwards against a stop in the longitudinal direction 10.

In this case a stop plate 14 serves as a stop, which is moved up and held to the lower end face of the guide tube opening 1.1 in the cutting position 12 as shown in FIG. 1d, preferably completely covers this guide tube opening 1.1 before starting the cutting process.

In a slice-shaped press piston turret 13, 13′ longitudinal press pistons 4.1-4.5 are arranged circularly around its axis of rotation, the cross-sections of each of which correspond to one of the cross-sections 1.1′-1.5′ of the guide tube openings 1.1-1.1.5 and are arranged in the press piston turret 13 in such a way that they fit exactly and preferably liquid-tight into one of the guide tube openings 1.1-1.5 when they are in the cutting position 12 above this matching guide tube opening.

The press piston turret 13 is rotatable about the likewise upright switching axis 13′, which extends parallel to the switching axis 1′ but is offset relative thereto in a transverse direction, so that, at a certain guide tube opening 1.1 located at the cutting position, the longitudinal press piston 4.1 having the same cross-section 4.1′ can be positioned above this guide tube opening 1.1 by corresponding rotation of the press piston turret 13.

When the lower, free end of the piston rod 6a approaches the upper side of the longitudinal press piston 4.1, which is still held in the press piston turret 13 and is in the cutting position 12, these are automatically connected to one another by means of a coupling 9, in that at the lower free end of the piston rod 6a on the one hand and/or at the upper side of each of the longitudinal press pistons 4.1-4.5 on the other hand there are corresponding cooperating coupling parts 9a, b.

The coupling parts 9a located on the upper side of the longitudinal press pistons 4.1-4.5 lie on a circular path around the switching axis 13′ of the press piston turret 13. When the corresponding longitudinal press piston 4.1 is in alignment and above the cutting position 12, it is exactly in the movement path of the other complementary coupling part 9b arranged at the front end of the piston rod 6a.

When withdrawing the piston rod 6a with the longitudinal press piston 4.1 on it, the longitudinal press piston 4.1 moves against a piston stop 15 or in this recess when reaching the corresponding recess in the press piston turret 13, so that when withdrawing the piston rod 6a further, the coupling 9 is released and the corresponding longitudinal press ram 4.1, which is now held again in the press piston turret 13 in the recess provided for the longitudinal press piston 4.1, either magnetically or by suitable latching elements there.

The construction of the cutting machine is simplified by the fact that the longitudinal press drive 6 is only existing above the cutting position 12.

Switching axis 1′ means that the guide tube revolver 1 can be rotated, but can also be locked in certain angular positions, so that it can be switched from one of the defined angular positions to the next.

In the following, instead of displacement direction 2 of the blade axis 3′, it is always spoken of the 1st transverse direction 11.1, without limiting the invention to this, although the displacement direction 2 can also be another direction running transverse to the longitudinal direction 10 of the guide tube turret 1.

The blade 3 is mounted on a slide 19 so that it can rotate about its blade axis 3′. The slide 19 can be moved in this direction 2 relative to the cutting base frame 18. The stop plate 14 is also supported by the slide 19, but can be adjusted at least in axial direction 10, if necessary also in the radial direction.

During the cutting process, blade 3 and stop plate 14 preferably move synchronously in the penetration direction 2, preferably 1. transverse direction 11.1, so that the resulting slice 101 is increasingly pushed through the slit between the cutting edge 3a of the blade 3 and the functional edge 14a of the stop plate 14 facing the blade.

The functional edge 14a is—in axial direction 10, for example when viewed from below—preferably concave curved and runs in this viewing direction aligned or slightly radially outwards, especially at a constant distance over the length of the functional edge, from the circular circumference of the cutting edge 3a.

Preferably the stop plate 14 and thus its functional edge 14a can also be adjusted in the 1st transverse direction 11.1 according to FIG. 1a in relation to the slide 19 and thus the cutting edge 3a of the blade 3, preferably also during the cutting process.

These and all other movements of moving parts of the cutting machine are controlled by a control not shown.

FIG. 1d shows a state of the cutting machine in which two processes are shown simultaneously, but which do not have to occur simultaneously in practice:

On the one hand, the stop plate 14 has been raised to such an extent that it is in direct contact with the lower end face of the guide tube revolver 1, the cutting end 1a, as may be necessary as a stop for the longitudinal pressing of the loaf 100 at cutting position 12.

Furthermore, the blade 3 is shifted so far away from the switching axis 1′ of the guide tube revolver 1 that it is completely outside the cross-section of the guide tube revolver 1 when viewed in longitudinal direction 10, so that the blade 3, which is supported on its underside by the slide 19, is freely accessible from the top over its entire surface and can be removed upwards and exchanged for another blade after loosening a quick release 20.

The recesses 21 shown in FIGS. 2a to 2c arranged around the centre of the blade 3, preferably on a circular path, and the openings 22 through the disc-shaped blade 3 primarily serve to reduce the weight of the blade 3 and the openings 22 also serve as gripping openings for gripping the blade 3 when changing the blade.

According to the invention, holding magnets 7 are present outside the guide tube cross-section 1.1′, 1.2′ in the guide tube near its cutting face 1a, but in penetration direction 2 only near the end of the penetration distance 2′:

As shown in FIG. 2a viewed in longitudinal direction 10 on both sides of each guide tube opening at least one holding magnet 7, as a rule at least two holding magnets are arranged with respect to its penetration direction 2, here the radial direction with respect to the switching axis 1′ of the guide tube revolver 1 through the centre of the respective guide tube opening. The at least one holding magnet 7 is arranged only in the last third of the penetration distance 2′ to pull the blade 3 so that the blade edge 3a is in contact with the outlet end 2a of the penetration section 2′, which is located radially inwards with respect to the guide tube revolver 1, with pretension on the end face 1a of the guide tube revolver 1.

FIG. 4 shows—again viewed in longitudinal direction 10, generally in the longitudinal pressing direction—the arrangement of the holding magnets 7 with two guide tube openings 1.1, 1.2 running parallel next to each other, which additionally allow transverse pressing of the loaf inserted therein in a first transverse direction to the longitudinal direction 10 by means of a transverse pressing piston. Since in this case the penetration direction 2 often coincides with the transverse pressing direction, the length of the penetration distance 2′, which the blade edge 3a must cover through the cross-section of the guide tube opening, also changes with the dimension of the transverse pressing.

To adapt to this change, two elongated blind holes 24 extending in the direction of penetration 2 are provided on both sides of each of the two guide tube openings, whereby a single such elongated blind hole 24 between the two guide tube openings 1.1, 1.2 is sufficient with a sufficiently small distance between the two guide tube openings 1.1, 1.2.

Along these blind holes 24, the holding magnets 7—preferably by means of a magnet holder 25, which is still to be explained—can be inserted at different longitudinal positions into these blind holes 24, namely always in the direction of penetration 2 into the last or the last two insertion positions along the penetration path 2′ near their outlet side 2a.

FIGS. 1a and 3 show the positioning and fastening of the holding magnets 7 in axial direction 10:

FIG. 1a shows in the right edge region a guide tube revolver 1, which is formed in one piece in the axial direction 10, in the center and in the left region, on the other hand, an embodiment in which it consists of 10 consecutive discs 1A, 1B in the axial direction, of which only the first two are shown, while in practice then the entire length of the guide tube revolver 1 is composed of discs of the same thickness. The discs 1A, 1B are of course arranged and fixed in such a way that their guide tube openings 1.1,1.2 are aligned with each other.

According to FIG. 3, the holding magnet can then be inserted from its rear side into the frontmost disc 1A facing the blade 3, so that the front surface 1a is not interrupted by a holding magnet 7—even if inserted flush and fixed—as it is the case with a one-piece guide tube revolver 1, as shown in FIG. 1a at the lower right end of the guide tube revolver 1.

According to FIG. 3, there are blind holes 24 in the 1^{st}, the cutting sided disc 1A next to the guide tube openings 1.1, the blind holes 24 are open towards the rear of this disc 1A facing away from the front end 1a.

As shown in the left half of FIG. 3, this blind hole 24 can have an axial section with an internal thread 23 into which a magnetic holder 25 with a corresponding external thread 23 can be screwed, which holds the holding magnet 7 at the bottom of the blind hole 24 with its front face. The magnetic holder 25 can be sealed against the inner circumference of the blind hole 24 by means of the grooves in its outer circumference and the O-ring 16 inserted therein, or by other means.

The right half of the figure shows a much simpler design, in which the magnet holder 25—with or without sealing—has such an axial length that after inserting the holding magnet 7 into the blind hole 24 and then inserting the magnet holder 25 it is aligned with the back of the disc 1A and secured in its axial position by the following disc 1B.

### REFERENCE SIGN LIST

1 guide tube, guide tube revolver
1′ totary axis, switching axis
1a cutting end, end face
1b loading end, end face
1.1, 1.2 guide tube opening
1.1′, 1.2′ internal cross section
2 penetration direction
2′ penetrating distance
2a outlet side, outlet end
3 blade
3′ blade axis
3a cutting edge
4.1-4.5 longitudinal press piston
4′ longitudinal pressing direction
5.1-5.5 transverse-pressing piston
5′ transverse pressing direction
6 congitudinal press drive
6a piston rod
6b cylinder
7 holding magnet
8 discharg conveyor
9 coupling
9a, b coupling part
10 axial direction, longitudinal direction, longitudinal pressing direction
11 transverse direction, radial direction
11.1 first transverse direction,
11.2 second transverse direction,
12 cutting position
13 press piston revolver
13′ rotary axis, switching axis
14 stop element, stop plate
14a functional edge
15 piston stop
16 O-ring
17 intermediate plate
18 cutting base frame
19 slide
20 central lock, quick release
21 recess
22 opening
23 internal thread, external thread
24 blind hole
25 magnetic holder
100 loaf, material to be cut
101 slice
A spacing
D thickness

1. Cutting machine for cutting a material (2) to be cut into slices (101) with
at least one guide tube (1) running in the longitudinal direction (10) with at least one guide tube opening (1.1, 1.2) open at each end face for receiving the material to be cut (100),
a blade (3) which is positioned in the longitudinal direction (10) directly at the cutting end face (1a) of the guide tube (1),
at least one holding magnet (7) in or at the guide tube (1) positioned in the longitudinal direction (10) near the front, cutting end face (1a) of the guide tube (1), which pulls the blade (3) into contact with the front end face (1a) of the guide tube (1),
characterised in that
in the penetration direction (2) of the blade (3) into the guide tube cross-section (1.1′, 1.2′) the at least one holding magnet (7) is arranged only near the outlet side (2a) of the guide tube cross-section (1.1′, 1.2′).

2. Cutting machine according to claim 1,
characterised in that
the at least one holding magnet (8) is arranged transversely to the penetration direction (2) of the blade (3) close to the circumference of the guide tube cross-section (1.1′, 1.2′).

3. Cutting machine according to one of the preceding claims,
characterised in that
the holding magnet (7) is positioned in the longitudinal direction (10) so close to the front, cutting end face (1a) of the guide tube (1) that the tensile force of the holding magnet (7) at the front end face (1a) reaches a predetermined minimum tensile force.

4. Cutting machine according to one of the preceding claims,
characterised in that
the longitudinal position of the holding magnet (7) is adjustable.

5. Cutting machine according to one of the preceding claims,
characterised in that
the blade (3) is not thicker than 10 mm, in particular not thicker than 8 mm, in particular not thicker than 6 mm, in particular not thicker than 4 mm, in particular not thicker than 3 mm.

6. Cutting machine according to one of the preceding claims,
characterised in that
the blade (3) has an extension in the direction of penetration (2) of at least 10 mm, in particular at least 30 mm, in particular at least 50 mm.

7. Cutting machine according to one of the preceding claims,
characterised in that
the blade (3) is made of soft magnetic stainless steel, in particular soft magnetic stainless high-alloy steel,
and/or
the variety number of the material of the blade (3) begins with 1.40-1.46, preferably with 1.40 and its subsequent counter number is between 16 and 34, preferably 20 or 21, in particular the variety number is 1.4021.34
and/or
wherein the nickel content of the material of the blade (3) is a maximum of 2.5% by weight and the carbon content should be a maximum of 1.2% by weight, while the chromium content should be at least 10.5% by weight, better 13-15% by weight.

8. Cutting machine according to one of the preceding claims,
characterised in that
the blade (3) is a blade (3) ground on one side only, on the side remote from the guide tube (1).

9. Cutting machine according to one of the preceding claims,
characterised in that
the minimum tensile force of the individual holding magnet (7) mounted on the cutting end face (1a), in particular in relation to soft magnetic, stainless blade steel, is between 100 N and 10 N, better between 70 N and 20 N, better between 50 N and 30 N.

10. Cutting machine according to one of the preceding claims,
characterised in that
the sum of the minimum tensile forces of the holding magnets (7) present on a guide tube (1.1, 1.2) on the cutting end face (1a), in particular in relation to soft magnetic, stainless blade steel, is between 400 N and 40 N, better between 280 N and 160 N, better between 200 N and 120 N.

11. Cutting machine according to one of the preceding claims,
characterised in that
the at least one holding magnet (7) is arranged transversely to the penetration direction (2) of the blade (3) closer than 30 mm, better than 20 mm, better than 10 mm to the circumference of the guide tube cross-section (1.1′, 1.2′), closer than 30 mm, better than 20 mm, better than 10 mm
and/or
the at least one holding magnet (7) is detachably fastened to or at the guide tube (1).

12. Cutting machine according to one of the preceding claims,
characterised in that
the guide tube turret (1) consists of discs (1A, 1B) following one another in the axial direction (10),
the holding magnet (7) is inserted from the rear side into a blind hole (24) in the frontmost disc (1A) facing the blade (3) the blind hole (24) being open towards the rear side of this disc (1A) so that its front surface (1a) passes in front of the holding magnet (7).

13. Cutting machine according to one of the preceding claims,
characterised in that
either this blind hole (24) has an axial section with an internal thread (23) into which a magnet holder (25) with a corresponding external thread (23) can be screwed, which magnet holder holds the holding magnet (7) with its front end face at the bottom of the blind hole (24),
or the magnet holder (25) has such an axial length that, after insertion of the holding magnet (7) into the blind hole (24) and subsequent insertion of the magnetic holder (25), it is aligned with the rear side of the slice (1A).

14. Cutting machine according to one of the preceding claims,
characterised in that
the magnetic holder (25) is sealed with respect to the inner circumference of the blind hole (24), in particular by means of a groove incorporated in its outer circumference and an O-ring (16) inserted therein.

15. Method for cutting a material to be cut (100) into slices (101), the material is at least partially accommodated in a guide tube opening (1.1, 1.2) running in the longitudinal direction (10), whereby
the cutting edge (3a) of a blade (3) sweeps over the guide tube cross-section (1.1′, 1.2′) along the end face (1a), and
where the blade (3) is pulled to the front end face (1a) of the guide tube (1) by the force of a holding magnet (7),
characterised in that
the force of the holding magnet (7) is exerted against the blade (3) only near the outlet side (2a) of the penetration section (2′) through the guide tube cross-section (1.1′, 1.2′).

16. Method according to claim 15,
characterised in that
the position of the holding magnet (7) transverse to the longitudinal direction (10) is selected and, if necessary, changed as a function of the degree of transverse compression of a material (100) to be cut in the guide tube opening (1.1, 1.2).
